(19) United States
(12) Patent Application Publication
(10) Pub. No.: US 2004/0258163 A1
(43) Pub. Date: Dec. 23, 2004

(54) Video communication system and video coding method

(75) Inventors: Jae Shin Yu, Seoul (KR); Joo Min Kim, Seoul (KR); Heon Jun Kim, Sungnam-si (KR)

Correspondence Address: FLESHNER & KIM, LLP, P.O. BOX 221200, CHANTILLY, VA, 20153, US

(73) Assignee: LG Electronics Inc.

(21) Appl. No.: 10/849,864

(22) Filed: May 21, 2004

(30) Foreign Application Priority Data
May 22, 2003 (KR) 2003/32664

(51) Int. Cl. H04N 7/12

(52) U.S. Cl. 375/240.27; 375/240.2; 375/240.03; 375/240.24

(57) ABSTRACT

There is provided a video communication system, which is capable of preventing damage or loss of video data. The video communication system includes: a video encoder for performing a data hiding to an error information provided from the video decoder, transmitting a processed error information to the video decoder, and performing an error concealment with reference to the error information; and the video decoder for extracting an information on an error frame, providing the extracted frame information to the video encoder, extracting the hidden data provided from the video encoder, and performing an error concealment with reference to the extracted hidden data.

### BACKGROUND OF THE INVENTION

1. Field of the Invention

The present invention relates to a video communication system, and more particularly, to a video communication system and a video coding method, which is capable of preventing damage or loss of video data at a transmission process in network environment.

2. Description of the Related Art

Video coding process in a video communication system is shown in FIG. 1. Video data, that is, original video images, are compressed at an encoder in order to decrease bit rate. Compressed bit stream is segmented into fixed or variable segment packets and is multiplexed together with other data, such as audio data.

If error-free environment is secured at a network, the multiplexed packets are directly transmitted to the network. On the contrary, if such an error-free environment is not secured, forward error correction (FEC) channel coding is applied to the multiplexed packets in order for protection from transmission error.

Meanwhile, packets received at a receiver is demultiplexed, FEC decoded and unpacketized. Then, bit stream is transmitted to a decoder and reconstructed into the original video data. Also, in many practical applications, the network includes a packetization processing unit and a channel coding processing unit inside a source coder as an adaptation layer.

In the practical network environment, since the network does not secure bit error free transmission, channel encoding is demanded and forward error correction (FEC) is generally used for protection from the transmission error. In case the network does not secure quality of service (QOS), data packets are lost or damaged due to traffic congestion. Also, bit error occurs due to damage of physical channels.

In the Internet or wireless communication environment, error-free delivery of data packets may be performed using a repeat method or the like using automatic repeat request (ARQ). However, because of delay, the repeat method using the ARQ is not suitable for real time application. Further, because of network flooding, the ARQ method is never used in several applications, such as broadcasting or the like. Accordingly, it is very important to design codec that makes the compressed bit streams robust against transmission error.

Error control has several interesting characteristics.

First, the compressed bit streams are very sensitive to the transmission error. The reason is that one incorrectly reconstructed sample propagates error to consecutive samples through spatiotemporal prediction methods of a predictive coding and a variable length coding (VLC). Examples of such error propagation are shown in FIG. 2. It can be seen from FIG. 2 that the error influences following frames. Also, the influence on the following frames is different depending on bit error rate (BER). Due to the use of the VLC, one bit error may cause a loss of synchronization and thus the correctly received bits may be useless.

Second, video source and network environment is time-varying. Accordingly, it is almost impossible to derive optimal solutions based on statistical model of the source and network.

Third, video source has high data rate. Accordingly, codec operation must not be excessively complex and, in case of real time applications, must be designed more carefully.

Methods for making the compressed bit stream robust against the transmission error will now be described.

A method for adding redundancy to streams in source or channel is provided. According to “classical Shannon information” theory, after the source and channel are separately designed, if an optimized compression is performed in the source and a channel coding optimized to the network is performed in the channel, an error-free delivery can be realized. However, this theory is possible only when endless delay is allowed, so that its actual application is difficult.

For these reasons, “joint source and channel coding” is more practicable. The “joint source and channel coding” assigns whole redundancies to channel and source codec. Almost all error resilient encoding methods are applied on this assumption. Also, available source codec is designed inefficiently by intention and a large number of channel encoding redundancies are assigned, thereby limiting an error delay length.

When blocks are damaged due to the transmission error, the decoder conceals or hides the damaged blocks using an inherent relationship of spatiotemporal adjacent blocks. This is called “error concealment”. The reason why the damaged or lost blocks are recovered using the spatiotemporal adjacent blocks of the damaged blocks is that spatiotemporal predictive coding method is used in the source encoding. Although the source encoding needs no additional bits, an amount of calculation in the decoder increases.

The above-described transmission errors can be classified into random bit error and erasure error. Here, the random bit error represents a case that bits are incorrectly transmitted intermittently in the encoded stream, and the erasure error represents a case that bit stream is not transmitted correctly and information is lost during the transmission.

There are two approaches for coping with the transmission error. One is “traditional error control and recovery scheme”, such as FEC, ECC and ARQ, which focuses on lossless recovery. The other is “signal-reconstruction and error-concealment technique”, which approximates almost similarly to the original signal or makes an output signal of the decoder similar to the original signal in view of human's vision.

The approaches can be again classified into three methods, depending on the encoder and decoder. A first method is performed in the source and channel encoder and makes bit streams robuster than potential error. A second method is performed in the decoder based on error detection. This method conceals or hides error. A third method is performed in both the source encoder and the decoder. Error information detected in the decoder is transmitted to the encoder using feedback channel and the encoder performs error resilience encoding based on the error information.

However, the above-described methods using the error resilience and error concealment have disadvantages in that all occurring errors cannot be eliminated.

### SUMMARY OF THE INVENTION

Accordingly, the present invention is directed to a video communication system and a video coding method that substantially obviate one or more problems due to limitations and disadvantages of the related art.

An object of the present invention is to provide a video communication system and a video coding method, which are capable of preventing a damage or loss of video data and an error propagation during data transmission in a network environment.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a video communication system includes a video encoder and a video decoder, wherein the video encoder includes: a data hiding processing unit for performing a data hiding to an error information provided from the video decoder, and transmitting a processed error information to the video decoder, the processed error information having a hidden data; and a first error concealment processing unit for performing an error concealment with reference to the error information, and wherein the video decoder includes: a data extraction unit for extracting an information on an error frame, providing the extracted frame information to the video encoder, and extracting the hidden data provided from the video encoder; and a second error concealment processing unit for performing an error concealment with reference to the extracted hidden data.

According to another embodiment of the present invention, a video decoder includes: a variable length decoding (VLD) processing unit for receiving a compressed video stream from a video encoder and performing a variable length decoding; a data extraction unit for extracting a hidden data from the variable length decoded stream, the hidden data being transmitted using a data hiding from the video encoder, extracting an information on an error frame, and providing the extracted frame information to the video encoder; and an error concealment processing unit for performing an error concealment with reference to the extracted hidden data.

According to a further another embodiment of the present invention, a video coding method includes the steps of: extracting an error frame information at a video decoder during a decoding and providing the extracted error frame information from the video decoder to a video encoder; performing an error concealment at the video encoder with reference to the error frame information provided from the video decoder, performing data hiding to a reference frame used in an error concealment, and transmitting the hidden data to the video decoder; and extracting the hidden data transmitted from the video encoder at the video decoder, modifying a reference frame of a frame that is encoded using the extracted hidden data, and performing an error concealment.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a schematic view showing a video coding process of a related art video communication system;

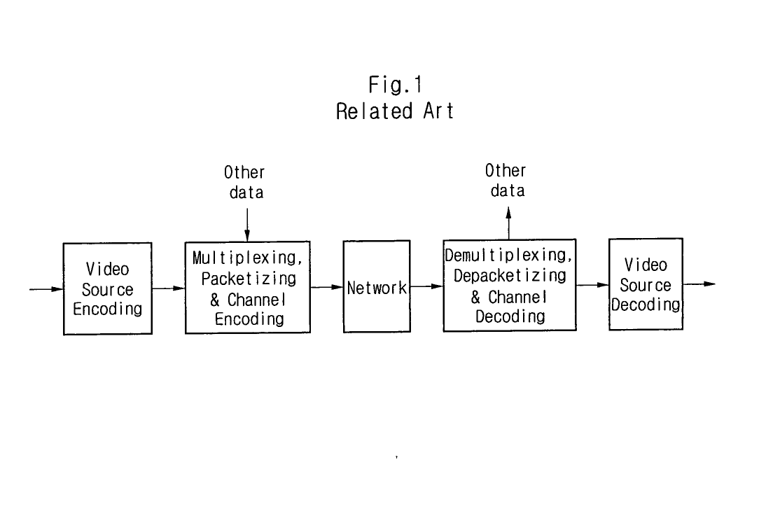

FIG. 2 is a view showing an influence of error on next frames in a related art video communication system;

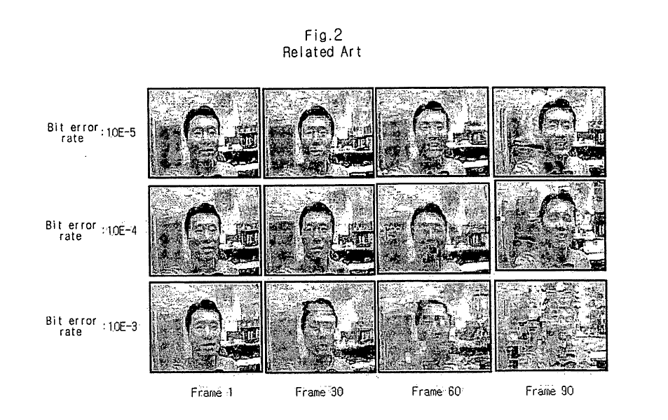

FIG. 3 is a view illustrating a video coding process of a video communication system according to the present invention;

FIG. 4 is a view of an example of application to which the video coding method of the present invention is applied;

FIG. 5 is a view of a data hiding using a quantization parameter in the video coding method according to the present invention; and

FIG. 6 is a view of a data hiding using a level value in the video coding method according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention provides a method that is capable of preventing damage or loss of video data, which is caused due to channel error in a network environment. Specifically, there is provided a video data encoding method, which is capable of preventing error propagation based on error information transmitted to the other part using data hiding.

Although some of error resilience methods are described as standard, the present invention is not subject to the standard. The data hiding used in the present invention relates to a method of embedding error information into video data of compression region. Picture quality of actual video data is not degraded and an amount of data is also reduced. Additionally, in order to extract data hided information, some methods require original video data, but the method of the present invention does not require the original video data. The data hiding technique adopted in this invention will be described later in detail.

Two general methods for coping with error occurrence will now be described in brief.

First, error resilience is performed in the encoder for robustness against error. In case when channel error occurs, the error in the corresponding frame is made to be propagated to the minimum. However, because a recovery for the error occurrence region is not performed, the picture quality is degraded in the corresponding region. Also, the damaged image is propagated to next frames and thus affects them. Here, the main reason why the damaged image is propagated is that most of the video compression methods use compression technologies based on motion vector.

Second, in case of error concealment, damaged regions due to error are recovered in the decoder. Such a recovering method copies data, which are located at the same position of a previous frame, or uses motion vectors of blocks, which are located adjacent to the error occurrence block. However, such error concealment has difficulty in recovering video data of the damaged blocks correctly. Specifically, in case when motion is great, a predicative error of the recovered block is great. Also, the video data of the incorrectly recovered block is propagated to next frames, such that the picture quality is degraded more seriously.

As described above, in order to provide video data having good picture quality to users in the error environment, the occurred error is made to be propagated at the corresponding frame to the minimum, and video data of the block in which the error occurs must be reconstructed more accurately, and the damaged video image must be prevented from propagating to next frames.

In this invention, the methods proposed in the standard are applied in order to propagate the occurred error at the corresponding frame to the minimum, the video data of the block in which the error occurs are reconstructed using the motion vectors of the adjacent blocks, and the error information transmission using data hiding and the error concealment in the video encoder are applied in order to prevent the error image to next frames.

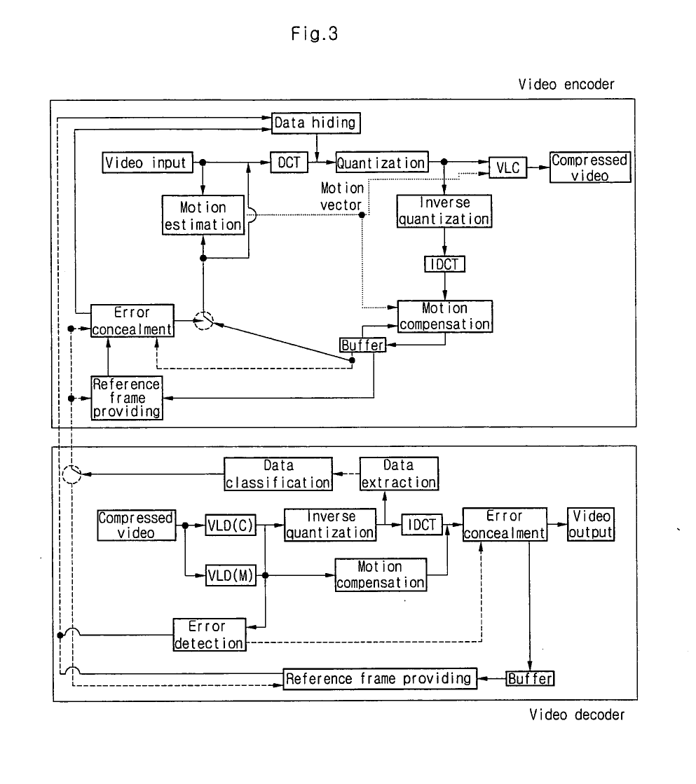

FIG. 3 is a schematic view illustrating a video coding process of a video communication system according to the present invention.

Before explaining the video coding process of the present invention, a video coding process in the related art video communication system will now be described in brief.

According to the video coding process in the related art video communication system, motion estimation and motion compensation are performed to an input video image to extract motion vector. Then, discrete cosine transform (DCT) and quantization are performed to corresponding difference image. Variable length coding (VLC) is performed to the quantized data in order for more efficient data compression. Then, an original image is restored by combining the previous image and the inverse quantized and inverse DCTed image. A difference image of next image is obtained using the restored image. In this manner, video data compression is achieved.

Meanwhile, referring to FIG. 3, the video communication system of the present invention performs the error information transmission using data hiding in the video encoder and also performs error concealment in the video encoder. For this purpose, the video decoder extracts data from a frame in which an error occurs, and provides the extracted frame information to the video encoder. The video decoder itself also performs the error concealment.

Error resilience in the video communication system of the present invention will now be described.

In case an error occurs during a decoding process, an error detection unit of the video decoder detects the error and an error concealment processing unit of the video decoder performs an error concealment in order to reconstruct a video data of the block in which the error occurs. At this point, the error concealment is performed by applying motion compensation to a reference frame using an average of motion vectors of blocks (for example, upper and lower blocks) adjacent to the block in which the error occurs. In addition, the video decoder performs the error concealment and provides an error information (an information about whether an error occurs in group of block (GOB) or not) and number of the frame in which the current error occurs.

The video encoder receives the error information and the frame number information. The video encoder converts a to-be-embedded information into a bit stream using data hiding. Then, the video encoder embeds 1 bit through modification of quantization parameters (QPs) of respective blocks and transmits the resultant data to the video decoder. Such a data hiding technique will be described later.

A hidden data extraction unit of the video decoder receiving the embedded information extracts the hidden data during an inverse quantization process. The hidden data extraction unit extracts 1-bit data from QP value of each block to configure bit stream of the embedded data, and transmits the error information and number of the frame, in which the current error occurs, to a data classification processing unit

If the information received from the hidden data extraction unit is the error information and the information on number of the frame in which the error occurs, the data classification unit transmits the information to a reference frame providing unit and error concealment processing unit of the video encoder. The reference frame providing unit of the video encoder, which receives the frame number information, takes a frame corresponding to the number of the frame, in which the error occurs, from a buffer and transmits it to an error concealment processing unit of the video encoder.

The error concealment processing unit of the video encoder performs an error concealment with respect to the frame, in which the error occurs, using the frame number information and the error information in the same manner as the decoder, in which the error concealment is performed by applying motion compensation to the reference frame using the average of motion vectors of the upper and lower blocks.

The frame to which the error concealment is performed in the above procedures becomes a reference frame of a current to-be-encoded frame and a modified reference frame information is transmitted to the data hiding processing unit of the video encoder. The data hiding processing unit of the video encoder embeds the reference frame information into the current encoding frame using the data hiding technique, and transmits the embedded reference frame information to the error information provider (that is, the video decoder). At this point, the data hiding that is performed in the video encoder is processed during the quantization.

The data extraction unit of the video decoder, which has first transmitted the error information, extracts the embedded reference frame information during the inverse quantization and transmits the extracted reference frame information to the data classification processing unit. The data classification processing unit transmits the reference frame information to the reference frame providing unit of the video decoder. The reference frame providing unit set a frame corresponding to the received reference frame as a reference frame of a current to-be-decoded frame and decodes following video images.

In this manner, the video image in which the error occurs can be normally recovered and the error can be prevented from influencing the following frames by sharing the error information between the video decoder and the video encoder and performing the mutual error concealment.

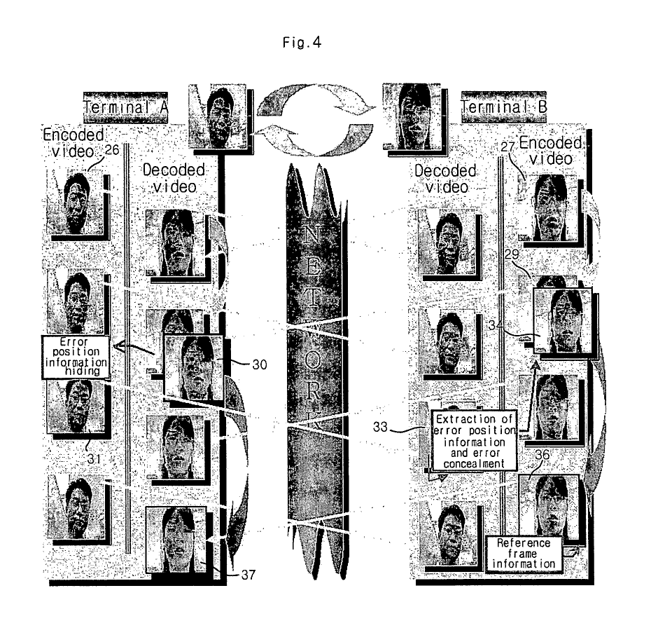

An example of application adopting the video coding method of the present invention is shown in FIG. 4.

As shown in FIG. 4, when two terminals each having both the video encoder and the video decoder mounted thereon communicate with each other, the video encoders encode corresponding frames and transmit the encoded video images 26 and 27 to the opposite terminals, respectively. The transmitted video data are recovered by the video decoders, respectively.

However, if the video image transmitted after encoding a video image 29 is damaged due to an error, the video image of the damaged block is recovered like a video image 30 through the error concealment. Then, GOB number (error position information) of the damaged block is embedded (data hiding) into a to-be-encoded image 31 and then transmitted. The error position information is extracted from the received video image 33. Then, like the video image 34, the error concealment is performed in the video encoder, and the video 34 is selected as a reference frame of a current to-be-encoded frame 36 and the encoding is performed. A reference frame number is embedded into the encoded video image 36 and then transmitted. The modified reference frame number is extracted from a received video image 37. Then, The video image 30 is selected as the reference frame and the decoding is performed.

Since the present invention provides good picture quality to the users by transmitting video data robust against the error in the network environment in which the error occurs, applications such as video telephone can be activated. These activations are expected to promote contents industries and accelerate the activation of basic industries.

The data hiding technique that is applied in this invention will now be described.

Data hiding is a technique that hides information in digital multimedia and, if necessary, extracts the hidden information. The data hiding can be largely classified into two categories. One requires an original image and the other does not require an original image when the hidden information is extracted. The data hiding that does not require the original image will be used in this invention.

In this invention, the data hiding is performed in the video compression. When the input image is compressed, the data hiding can be performed using parameters, which are used in the data compression, or by changing values that are dependent on the inputted video image. In order to achieve the data hiding in the video compression, there must be values that do not affect the picture quality or amount of compressing data, even if original parameter or data are changed through the data hiding. Such values are quantization parameter (QP) and “level” value. The level value is given by dividing DCT coefficient by quantization parameter.

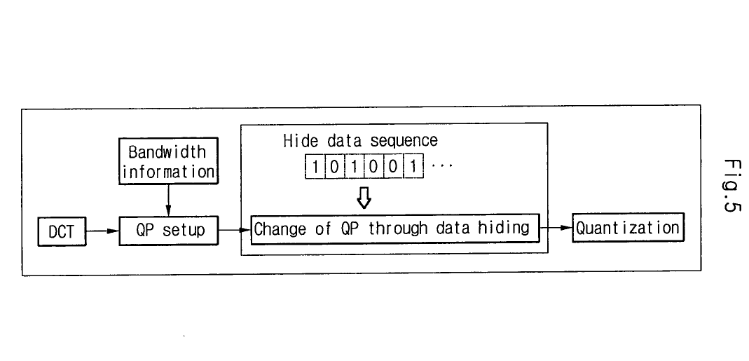

FIG. 5 illustrates the data hiding using the quantization parameter in the video coding method according to the present invention.

As is well known, it is the quantization parameter that adjusts an amount of encoding data. The quantization parameter is a parameter that is used to divide the input image or its difference value by DCT coefficient. If the quantization parameter increases, a value divided by the DCT coefficient becomes large, so that an amount of the encoding data decreases. On the contrary, if the quantization parameter decreases, a value divided by the DCT coefficient becomes small, so that an amount of the encoding data increases.

When the video moving pictures are received and transmitted through the network, data are compressed to match with bandwidth of the network. If the bandwidth of the network is wide, an amount of communication data becomes large, so that an encoding amount increases and thus the picture quality is improved. On the contrary, if the bandwidth of the network is narrow, an amount of communication data becomes small, so that an encoding amount decreases and thus the picture quality is degraded. Considering these network conditions, the amount of the encoding data is adjusted using the quantization parameter. At this point, the data hiding is performed.

Referring to FIG. 5, the discrete cosine transform (DCT) is performed to the input image or its difference image and then an appropriate quantization parameter is set, considering the bandwidth of the network. The quantization parameter is used to decode the compressed video image after entering a macroblock header. At this point, the data hiding is performed before the quantization is carried out using the quantization parameter. Here, the data hiding can be performed as follows:

QP_new %2==Hide bit[k]

QP_new: No change

QP_new %2 !=Hide bit[k]

QP_new=QP_new+1;

Hide bit[k]: bit stream of data to be hidden

If the data hiding is performed in the above manner, the hidden data can be extracted based on the quantization parameter while the decoder decodes the compressed data. If the quantization parameter in the decoder is an even number, the hidden data becomes “0”, and if the quantization parameter is an odd number, the hidden data becomes “1”.

At this point, the quantization parameter is slightly changed at the encoder in order for the data hiding. In other words, when the data to be hidden and the quantization parameter are divided by 2, if the remainders are equal to each other, the value of the quantization parameter increases by 1, thereby making the remainders equal to each other. In this case, the divisor of the DCT coefficient increases, so that an amount of the encoding data is reduced. However, human's eyes cannot almost recognize the degradation of the picture quality.

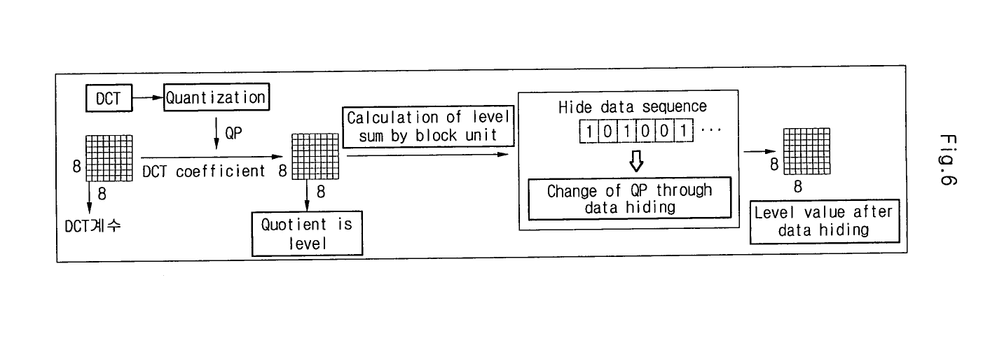

FIG. 6 is a view of a data hiding process using the level value in the moving picture coding method according to the present invention. In other words, in FIG. 6, data hiding is performed to the “level” value, which is given by quantizing the DCT coefficient of the input image or difference image.

According to the moving picture coding method of the present invention, the DCT is performed to the input image or difference image for the purpose of compression. Then, considering the transmission bandwidth, the quantization parameter is assigned to adjust an amount of encoding bit. The DCT coefficient is divided by the quantization parameter.

In FIG. 6, the DCT is performed by 8×8 block unit. The quantization parameter is applied to the DCTed block and the coefficient is divided. When the coefficient is divided by the quantization parameter, the resultant quotient is referred to as “level”. The data hiding is performed using the levels produced at each block. Here, the data hiding can be expressed as follows:

LevelSum %2==Hide Bit[k]

Level: No change

LevelSum %2 !=Hide Bit[k]

A value of a level having the lowest significance decreases by 1

LevelSum: Sum of all levels of blocks.

The reason why the data hiding is performed not in the respective levels but in the sum of levels by block unit is that the picture quality is affected when the data hiding is performed to the respective levels. As the quantization parameter becomes larger, one level's range of DCT coefficient becomes wider, because the level is the quotient of the value given by dividing the DCT coefficient by the quantization parameter.

For example, in case the level values are all equal to 1, if the quantization parameter is 10, the available DCT coefficient ranges from 10 to 19, and if the quantization parameter is 30, the available DCT coefficient ranges from 30 to 59. Thus, when the sum of the levels is calculated by 8×8 block unit and divided by 2, if the resultant remainder and the data bit to be hidden are equal to each other, the level is not changed, and if not, a value of a level having the lowest significance decreases by 1.

Here, the level having the lowest significance represents a region having the least sensitivity to human's eyes. Meanwhile, human's eyes are least sensitive to high frequency range. Therefore, if the data bit to be hidden and the remainder made by dividing the “level sum” by 2 are not equal to each other, the value of the level having the highest frequency decreases by 1.

If the “level sum” is “16” and the bit to be embedded is “1”, the value of the “level” corresponding to the highest frequency block among the blocks decreases by “1”. Thus, the “level sum” becomes “15”, so that the bit to be hidden and the remainder given by dividing the “level sum” by 2 are made to be equal to each other.

However, a problem occurs when the “level sum” is “1”. If the “level sum” is “1” and the bit to be hidden is “1”, a sum of the total blocks becomes “0” when the level value of the region having the lowest sensitivity decreases by 1. However, since the level of the block whose original sum is “0” cannot be decreased any more, the data hiding is not performed. In this case, the block whose “level sum” is changed from “1” to “0” through the data hiding cannot be distinguished from the block whose original “level sum” is “0” and having no data hiding.

The present invention makes use of a following method in order to prevent these errors. In case the “level sum” is “1” and the data to be hidden is “1”, data is embedded into the corresponding block. In this case, the “level sum” is not changed. In case the “level sum” is “1” and the data to be hidden is “0”, the “level sum” of the corresponding block is changed to “0” and the data hiding is not performed. When the “level sum” is “0”, the decoder considers that there is no data hiding in the corresponding block.

In this manner, if the data to be hidden and the remainder made by dividing a sum of the blocks by 2 are equal to each other, the levels of all the blocks, except for the block having the “level sum” of “1”, are not changed, and if not, the data can be hidden by decreasing the level of the region having the lowest sensitivity by 1.

In case of the block having the “level sum” is “1”, if the data to be hidden is “1”, the data is hidden. On the contrary, if the data to be hidden is “0”, the data is not hidden, but only the level value of the block is changed to “0”. When the “level sum” is “0”, the data hiding is not performed.

According to the present invention, it is possible to prevent the picture quality from being degraded due to the damage or loss of video data transmitted in the network environment, in which the error occurs, and to prevent the error image from being propagated to the next consecutive frames.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A video communication system comprising a video encoder and a video decoder, wherein the video encoder includes:
a data hiding processing unit for performing a data hiding to an error information provided from the video decoder, and transmitting a processed error information to the video decoder, the processed error information having a hidden data; and
a first error concealment processing unit for performing an error concealment with reference to the error information, and
wherein the video decoder includes:
a data extraction unit for extracting an information on an error frame, providing the extracted frame information to the video encoder, and extracting the hidden data provided from the video encoder; and
a second error concealment processing unit for performing an error concealment with reference to the extracted hidden data.

2. The video communication system of claim 1, wherein the processed error information is embedded into an encoded data and transmitted from the data hiding processing unit to the video decoder.

3. The video communication system of claim 1, wherein the processed error information is a reference frame number of a frame that is encoded when the video encoder performs the error concealment.

4. The video communication system of claim 1, wherein the extracted frame information is an information that represents whether or not the error occurs in each GOB (group of block).

5. The video communication system of claim 1, wherein the video encoder performs the data hiding using a quantization parameter with respect to an encoding video image and/or a level value of a block to which a discrete cosine transform (DCT) is performed.

6. The video communication system of claim 5, wherein the level value is a value is given by dividing discrete cosine transform coefficient by the quantization parameter.

7. The video communication system of claim 1, wherein the first and second error concealment processing units perform the error concealment by calculating average of motion vectors of blocks surrounding an error block and performing motion compensation to a reference frame.

8. The video communication system of claim 7, wherein the surrounding blocks for obtaining the average of the motion vectors are upper and lower blocks of a block in which the error occurs.

9. A video decoder comprising:
a variable length decoding (VLD) processing unit for receiving a compressed video stream from a video encoder and performing a variable length decoding;
a data extraction unit for extracting a hidden data from the variable length decoded stream, the hidden data being transmitted using a data hiding from the video encoder, extracting an information on an error frame, and providing the extracted frame information to the video encoder; and
an error concealment processing unit for performing an error concealment with reference to the extracted hidden data.

10. The video decoder of claim 9, wherein the hidden data is extracted during an inverse quantization.

11. The video decoder of claim 9, wherein the video encoder performs the data hiding using a quantization parameter with respect to an encoding video image and/or a level value of a block to which a discrete cosine transform (DCT) is performed.

12. The video decoder of claim 9, wherein the hidden data extracted at the data extraction unit is a reference frame number of a frame that is encoded when the video encoder performs the error concealment.

13. The video decoder of claim 9, wherein the extracted frame information is an information that represents whether or not the error occurs in each GOB (group of block).

14. The video decoder of claim 9, wherein the error concealment processing unit performs the error concealment by calculating average of motion vectors of blocks surrounding an error block and performing motion compensation to a reference frame.

15. A video coding method comprising the steps of:
extracting an error frame information at a video decoder during a decoding and providing the extracted error frame information from the video decoder to a video encoder;
performing an error concealment at the video encoder with reference to the error frame information provided from the video decoder, performing data hiding to a reference frame used in an error concealment, and transmitting the hidden data to the video decoder; and
extracting the hidden data transmitted from the video encoder at the video decoder, modifying a reference frame of a frame that is encoded using the extracted hidden data, and performing an error concealment.

16. The video coding method of claim 15, wherein the extracted frame information is an information that represents whether or not the error occurs in each GOB (group of block).

17. The video coding method of claim 15, wherein the video encoder performs the data hiding using a quantization parameter with respect to an encoding video image and/or a level value of a block to which a discrete cosine transform (DCT) is performed.

18. The video coding method of claim 15, wherein the video encoder and the video decoder perform the error concealment by calculating average of motion vectors of blocks surrounding an error block and performing motion compensation to a reference frame.
